(19) United States
(12) Patent Application Publication
(10) Pub. No.: US 2015/0345773 A1
(43) Pub. Date: Dec. 3, 2015

(54) OPTICAL SEMICONDUCTOR ILLUMINATING APPARATUS

(71) Applicant: POSCO LED COMPANY LTD., Yongin-si (KR)

(72) Inventors: Seok Jin KANG, Yongin-si (KR); Yoon Gil JANG, Yongin-si (KR); Sang Hyuk KIM, Yongin-si (KR); II PARK, Yongin-si (KR); Su Woon LEE, Yongin-si (KR); Min A. JEONG, Yongin-si (KR)

(21) Appl. No.: 14/713,640

(22) Filed: May 15, 2015

(30) Foreign Application Priority Data
May 29, 2014 (KR) 10-2014-0065362
May 29, 2014 (KR) 10-2014-0065363

(51) Int. Cl. F21V 31/00; F21V 17/12; F21V 23/00

(52) U.S. Cl. CPC F21V 31/005; F21V 23/001; F21V 23/007; F21V 17/12; F21Y 2101/02

(57) ABSTRACT

An optical semiconductor illuminating apparatus includes a light emitting module including semiconductor optical elements, a casing part disposed over the light emitting module and having a switching mode power supply (SMPS) embedded therein, a first airtightness part including a packing frame fixed to an outer side of an edge of a communication slot penetrating through a side surface of the casing part, and a second airtightness part provided to an upper side of the casing part.

### CROSS-REFERENCE TO RELATED APPLICATIONS

This application claims priority from and the benefit of Korean Patent Application No. 10-2014-0065362, filed on May 29, 2014, and Korean Patent Application No. 10-2014-0065363, filed on May 29, 2014, which are hereby incorporated by reference for all purposes as if fully set forth herein.

### BACKGROUND

1. Field

The present invention relates to an optical semiconductor illuminating apparatus.

2. Discussion of the Background

An optical semiconductor such as a light emitting diode (LED) or a laser diode (LD) is one of the components that have been recently spotlighted widely as an illuminating apparatus due to lower power consumption, a longer lifespan, more excellent durability, and significantly higher brightness as compared with an incandescent lamp and a fluorescent lamp.

Typically, since heating is inevitably caused from the optical semiconductor in an illuminating fixture using the optical semiconductor described above, a heat sink should be necessarily installed at a portion generating heat to discharge the generated heat to the outside.

Therefore, the heat sink made of aluminum or an aluminum alloy, or copper or a copper alloy having excellent heat conductivity is typically used to solve a heating problem. The heat sink made of the metal material described above is provided with various types of radiation fins in order to improve heat dissipation performance by increasing a heat transfer area.

However, the heat sink including the radiation fins described above is manufactured by extrusion or die casting. A volume and weight of the heat sink has acted as a factor limiting a weight lightening and compact implementation of the illuminating apparatus.

Particularly, since a light emitting module connected to the heat sink generally has a constant light flux or quantity of light depending on an area thereof or the number of optical semiconductors, there was a problem that an increase and decrease in the light flux or the quantity of light depending on an installation and construction environment is itself impossible.

Meanwhile, the illuminating apparatus using the optical semiconductor described above generally has a structure in which the light emitting module having a plurality of optical semiconductors disposed on one side surface of a housing is mounted.

In recent, the illuminating apparatus using the optical semiconductor described above is used for outdoor such as a streetlamp, a security light, a floodlight, and the like. In this case, a waterproofing and airtightness process should be implemented in the illuminating apparatus in order to prevent water and foreign material penetration from the outside.

In this sense, it is possible to prevent water from being introduced along a sheath of a cable by using a cable gland.

However, since the cable gland has the cable which is directly connected up to an inner portion of the housing, it is cumbersome and inconvenient in that the entire housing needs to be separated and opened to check the inner portion of the housing when it is determined that a terminal connecting part of the cable is abnormal.

### SUMMARY

An object of the present invention is to provide an optical semiconductor illuminating apparatus capable of improving heat dissipation performance by inducing natural convection across inner and outer portions of the optical semiconductor illuminating apparatus.

Another object of the present invention is to provide an optical semiconductor illuminating apparatus which may be simply installed and constructed and actively take action against various construction environments such as expansion and reduction due to assembling and fastening.

Another object of the present invention is to provide an optical semiconductor illuminating apparatus capable of surely maintaining waterproofing and airtightness and improving workability even in a case of maintenance such as a repair, a replacement, and the like.

According to an exemplary embodiment of the present invention, there is provided an optical semiconductor illuminating apparatus including: a first light emitting module including one or more semiconductor optical elements; a second light emitting module including one or more semiconductor optical elements; and a supporting unit connecting the first light emitting module and the second light emitting module to each other so that the first light emitting module and the second light emitting module maintain a state in which the first light emitting module and the second light emitting module are disposed to be in parallel to each other while being spaced apart from each other by a predetermined interval, wherein air is circulated through edges at both sides and upper and lower surfaces of the first light emitting module and the second light emitting module through the interval.

According to another exemplary embodiment of the present invention, there is provided an optical semiconductor illuminating apparatus including: a light emitting module including semiconductor optical elements; a casing part disposed over the light emitting module and having a switching mode power supply (SMPS) embedded therein; a first airtightness part including a packing frame fixed to an outer side of an edge of a communication slot penetrating through a side surface of the casing part and preventing water and foreign materials from being introduced from the outside; and a second airtightness part provided to an upper side of the casing part to prevent the water and foreign materials from being introduced from the outside.

### BRIEF DESCRIPTION OF THE DRAWINGS

FIGS. 1(a) and 1(b) are perspective views showing an overall structure of an optical semiconductor illuminating apparatus according to an exemplary embodiment of the present invention;

FIG. 2 is a side view showing an operation state of the optical semiconductor illuminating apparatus according to the exemplary embodiment of the present invention;

FIG. 3 is an exploded perspective view showing an overall structure of a light emitting module of a module block, which is a main part of the optical semiconductor illuminating apparatus according to the exemplary embodiment of the present invention;

FIG. 4 is a perspective view showing an inside structure of a casing part, which is the main part of the optical semiconductor illuminating apparatus according to the exemplary embodiment of the present invention;

FIG. 5 is a cross-sectional view showing an inside structure of the optical semiconductor illuminating apparatus according to the exemplary embodiment of the present invention;

FIG. 6 is a cross-sectional view showing an inside structure of an optical semiconductor illuminating apparatus according to another exemplary embodiment of the present invention;

FIG. 7 is a perspective view showing an inside structure of a casing part, which is the main part of the optical semiconductor illuminating apparatus according to another exemplary embodiment of the present invention;

FIG. 8 is a perspective view showing an overall structure of a first airtightness part, which is the main part of the optical semiconductor illuminating apparatus according to another exemplary embodiment of the present invention;

FIG. 9 is an exploded perspective view showing an overall structure of the first airtightness part, which is the main part of the optical semiconductor illuminating apparatus according to another exemplary embodiment of the present invention; and

FIGS. 10 and 11 are perspective views of a structure of a supporting part of the first airtightness part, which is the main part of the optical semiconductor illuminating apparatus according to another exemplary embodiment of the present invention, viewed from various points.

### DETAILED DESCRIPTION OF THE ILLUSTRATED EMBODIMENTS

Advantages and features of the present invention and methods accomplishing them will become apparent from the following description of exemplary embodiments with reference to the accompanying drawings.

However, the present invention may be modified in many different forms and it should not be limited to exemplary embodiments set forth herein.

These exemplary embodiments may be provided so that this disclosure will be thorough and complete, and will fully convey the scope of the invention to those skilled in the art.

In addition, the present invention is defined solely by the scope of the claims.

Therefore, in some exemplary embodiments, components, operations, and technologies which are widely known are not described in detail in order to avoid obscuring the disclosed subject matter.

In addition, like reference numerals throughout the specification denote like element, and terms used (referred) in the present specification are for explaining the exemplary embodiments rather than limiting the present invention.

Unless explicitly described to the contrary, a singular form includes a plural form in the present specification, and the word “comprises” (or includes) used in the present specification will be understood to imply the inclusion of stated component and operations but not the exclusion of any other components and operations.

Unless otherwise defined, all terms (including technical and scientific terms) used in the present specification have the general meaning understood by those skilled in the art to which the present invention pertains.

In addition, the terms defined by the dictionary which are generally used should not be ideally or excessively defined unless the context clearly dictates otherwise.

Hereinafter, exemplary embodiments of the present invention will be described with reference to the accompanying drawings.

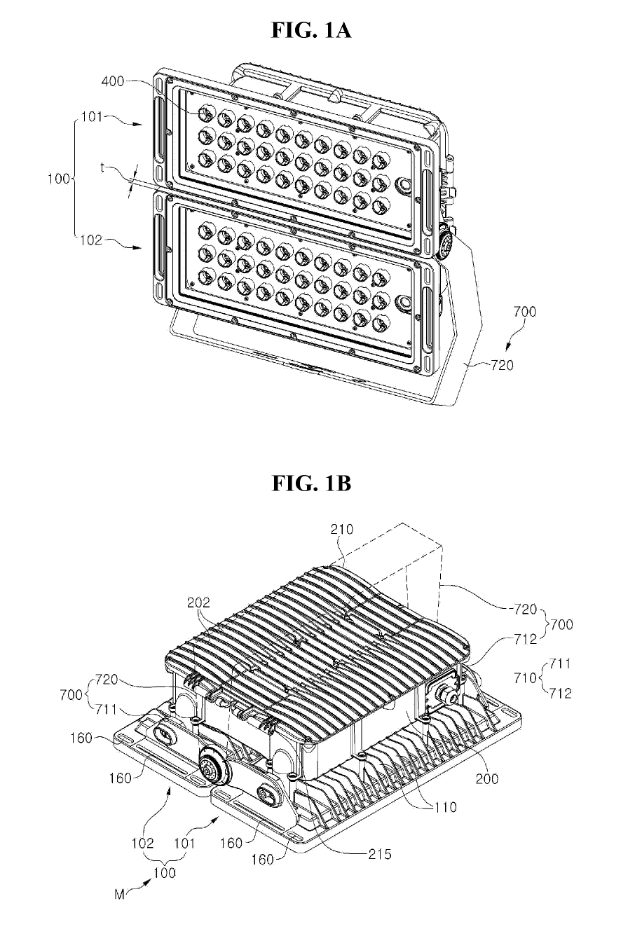

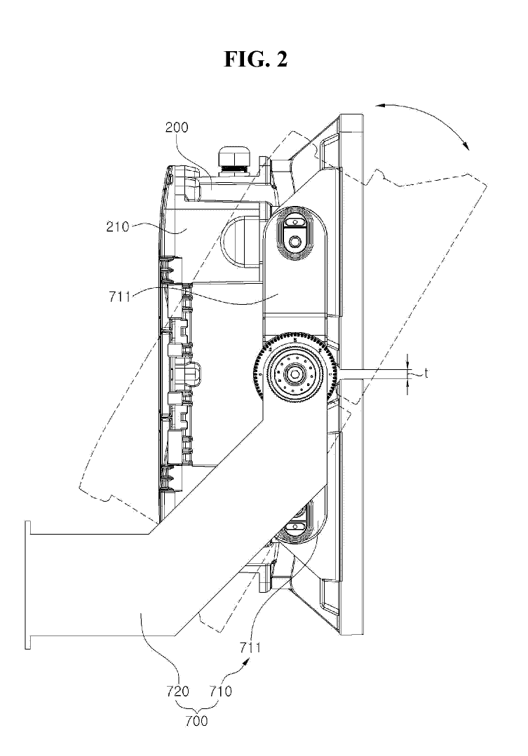

FIG. 1 is a perspective view showing an overall structure of an optical semiconductor illuminating apparatus according to an exemplary embodiment of the present invention and FIG. 2 is a side view showing an operation state of the optical semiconductor illuminating apparatus according to the exemplary embodiment of the present invention.

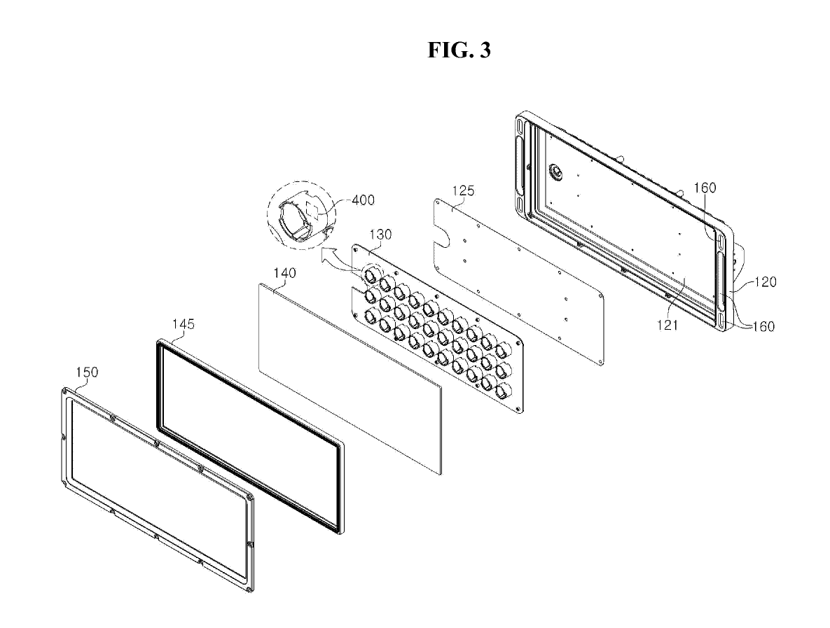

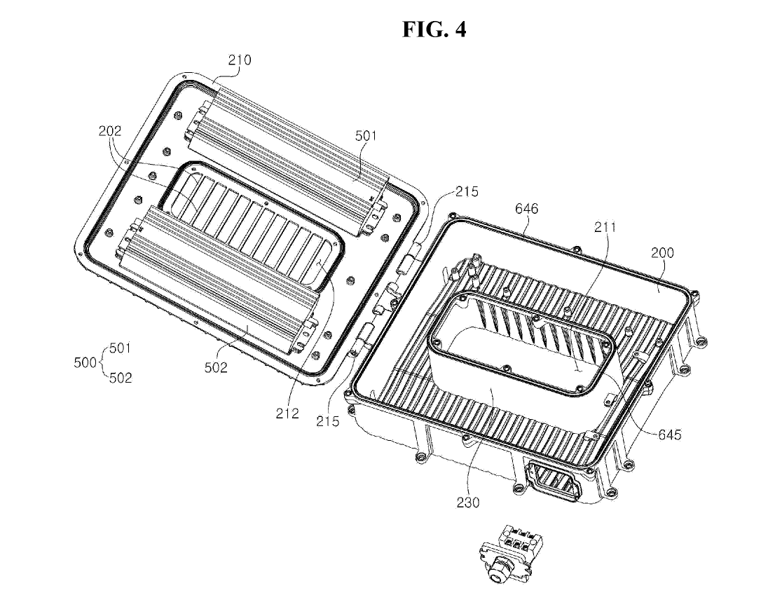

In addition, FIG. 3 is an exploded perspective view showing an overall structure of a light emitting module of a module block, which is a main part of the optical semiconductor illuminating apparatus according to the exemplary embodiment of the present invention and FIG. 4 is a perspective view showing an inside structure of a casing part, which is the main part of the optical semiconductor illuminating apparatus according to the exemplary embodiment of the present invention.

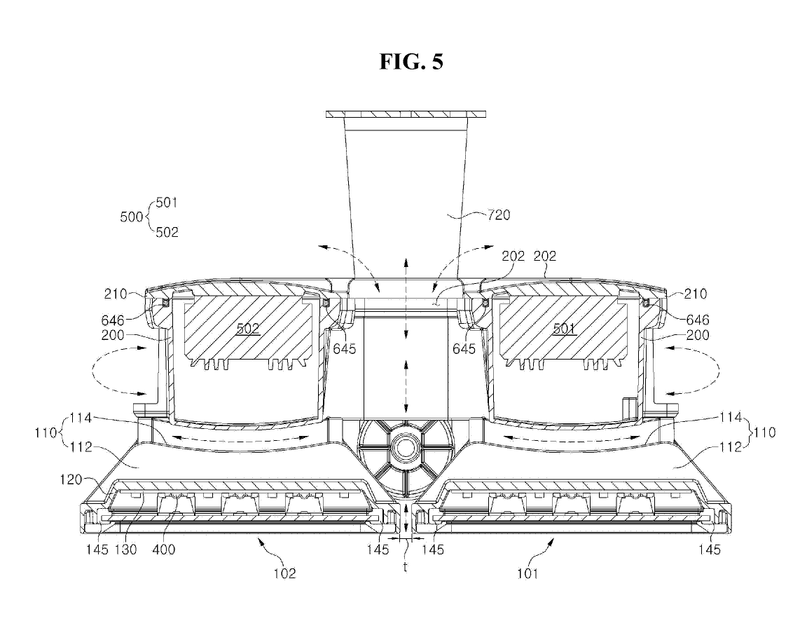

In addition, FIG. 5 is a cross-sectional view showing an inside structure of the optical semiconductor illuminating apparatus according to the exemplary embodiment of the present invention.

As shown, it may be understood that the present invention has a structure including a module block M and a supporting unit 700.

The module block M includes a plurality of light emitting modules 100 including semiconductor optical elements 400, wherein the semiconductor optical element 400 of each of the light emitting modules 100 functions as a light source.

The supporting unit 700 connects the plurality of light emitting modules 100 to each other so that the plurality of light emitting modules 100 maintain a state in which the plurality of light emitting modules 100 are disposed to be in parallel to each other while being spaced apart from each other by a predetermined interval t.

Therefore, air may be circulated (see a double-headed dotted line arrow of FIG. 5) through both edges and upper and lower surfaces of the plurality of light emitting modules 100 through the interval described above.

According to the present invention, the example as described above may be applied, and various examples below may also be applied.

First, the module block M includes a first light emitting module 101 including one or more semiconductor optical elements 400 and a second light emitting module 102 including one or more semiconductor optical elements 400.

The supporting unit 700 connects the first light emitting module 101 and the second light emitting module 102 to each other so that the first light emitting module 101 and the second light emitting module 102 maintain a state in which the first light emitting module 101 and the second light emitting module 102 are disposed to be in parallel to each other while being spaced apart from each other by a predetermined interval t.

Therefore, the air is circulated through both edges and upper and lower surfaces of the first light emitting module 101 and the second light emitting module 102 through the interval t.

Here, it may be appreciated that the supporting unit 700 has a structure including a connecting piece 710 connecting one end portions and the other end portions of the plurality of light emitting modules 100 to each other, and a bracket 720 having both end portions each connected to the connecting piece 710 to adjust a slope angle of the plurality of light emitting modules 100.

In more detail, the supporting unit 700 includes a first connecting piece 711 connecting one end portions of the first light emitting module 101 and the second light emitting module 102 to each other, a second connecting piece 712 connecting the other end portions of the first light emitting module 101 and the second light emitting module 102 to each other, and a bracket 720 having both end portions each connected to the first connecting piece 711 and the second connecting piece 712 to adjust a slope angle of the first light emitting module 101 and the second light emitting module 102.

The present invention shows the light emitting module configuring the module block M in two as the first and second light emitting modules 101 and 102, but is not necessarily limited to the structure. In some cases, the present invention may have a structure in which three or more light emitting modules are connected to each other.

Therefore, for n light emitting modules 100, the number of intervals t may be n−1.

For example, if the module block M has three light emitting modules 100, two intervals t may be formed.

In addition, the present invention shows the structure in which one module block M is provided, but is not necessarily limited to the structure described above. In some cases, it is also possible to use a structure in which the supporting unit 700 connects and supports a plurality of module blocks M to each other.

Meanwhile, the present invention further includes a plurality of switching mode power supplies (SMPSs) 500 including a first SMPS 501 and a second SMPS 502 corresponding to the plurality of light emitting modules 100, wherein the plurality of SMPSs 500 are disposed to be spaced apart from the plurality of light emitting modules 100, so as to be cooled by a convection circulation of air.

Here, the plurality of SMPSs 500 including the first SMPS 501 and the second SMPS 502 are disposed over the plurality of light emitting modules 100 to be accommodated in a casing part 200 in which a plurality of accommodation spaces are formed.

In this case, the plurality of SMPSs 500 are fixed on the accommodation spaces, thereby making it possible to further increase heat dissipation performance.

To this end, the present invention further includes a cover 210 that opens and closes an opened upper surface of the casing part 200, and the SMPS 500 is fixed on an inner surface of the cover 210.

Meanwhile, it may be seen that the light emitting module 100 has a structure including a housing 120 having an upper surface on which a plurality of first heat dissipation ribs 110 are disposed to be in parallel to each other, a substrate 130 disposed on a seating surface 121 of the housing 120 and having the semiconductor optical elements 400 arrayed thereon, an optical member 140 facing the substrate 130 and fixed to be seated in the housing 120, and an edge frame 150 of a frame shape fixing an edge of the optical member 140 and fastened to the housing 120, as shown in FIG. 3.

Here, it is preferable that the light emitting module 100 further includes a thermal pad 125 disposed on the seating surface 121 of the housing 120 so as to further increase heat dissipation efficiency and the substrate 130 is disposed on the thermal pad 125.

In this case, the light emitting module further includes a sealing member 145 made of an elastic material which is disposed to be close to the edge of the optical member 140 so as to prevent water from being introduced from the outside and maintain airtightness, and the edge frame 150 covers the sealing member 145 and is fastened to the housing 120.

In addition, the housing 120 of the light emitting module 100 has an edge through which a plurality of fastening slots 160 having a predetermined length and width along a formation direction of the edge penetrate, so as to provide spaces through which fastening holes penetrate when the light emitting module 100 itself is fixed to a wall surface, a protruding structure, a separate bracket, or the like.

In addition, the present invention further includes a hinge piece 215 connecting the casing part 200 and the cover 210 to each other as illustrated in FIG. 4, thereby making it possible to also conveniently allow a check and an installation.

In addition, the casing part 200 and the cover 210 may be further provided with first and second bent slots 211 and 212 penetrating through bottom surfaces of the casing part 200 and the cover 210, respectively, to partition accommodation spaces, in order to solve problems of the discharging of heat generated from the plurality of SMPSs 500 and the heating of the SMPSs 500 by convection air.

For reference, in order to distinguish the bent slots each formed in the casing part 200 and the cover 210, the bent slot formed in the casing part 200 is referred to as a first bent slot 211 and the bent slot formed in the cover 210 is referred to as a second bent slot 212, for convenience.

To this end, the casing part 200 further includes a partition part 230 extended along an edge of the first bent slot 211 to protrude from the bottom surface of the casing part 200 and having an upper end edge which is in contact with the second bent slot 212.

Meanwhile, the optical semiconductor illuminating apparatus according to the exemplary embodiment of the present invention may be applied to an example having a structure further including a plurality of first heat dissipation ribs 110 disposed on upper surfaces of the plurality of light emitting modules 100 to be in parallel to each other and a plurality of second heat dissipation ribs 202 disposed on the upper surface of the casing part 200 to be in parallel to each other, as illustrated in FIG. 5.

Here, it may be seen that the first heat dissipation rib 110 includes a rib body 112 having a trapezoidal shape and a cutting part 114 formed to be cut in a concave arc shape toward the light emitting module 100 along an edge of a short side of a trapezoid, and the bottom surface of the casing part 200 is spaced apart from the cutting part 114 by a predetermined interval.

Therefore, the air penetrates between the upper portion of the first heat dissipation rib 110 and the bottom surface of the casing part 200 and through the first bent slot 211 and circulates through the second bent slot 212 of the cover 210 and the like as illustrated, thereby making it possible to implement heat dissipation performance.

In addition, the casing part 200 may further include a first sealing member 645 mounted along an upper end edge of the partition part 230 to be closely adhered to the second bent slot 212 and a second sealing member 646 mounted along an upper end edge of the casing part 200 to be closely adhered to the edge of the cover 210, in order to maintain waterproofing and airtightness performance.

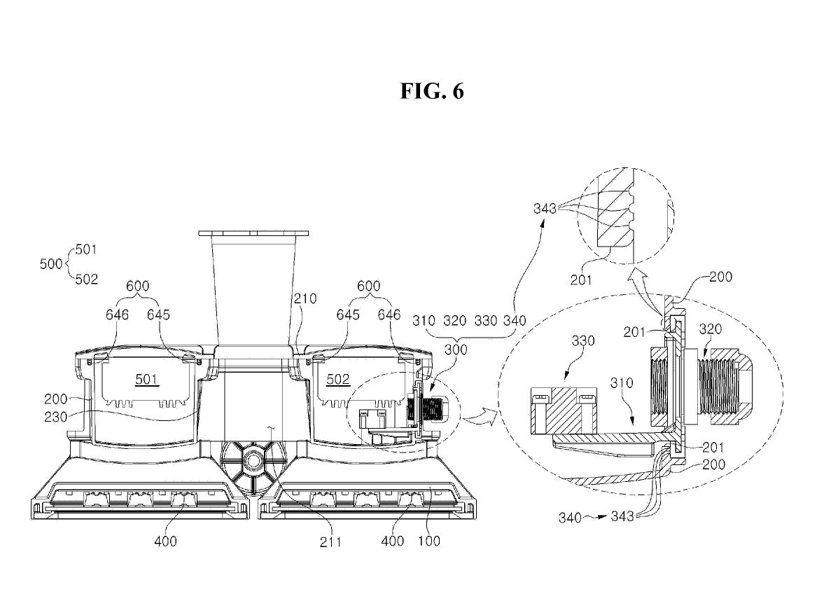

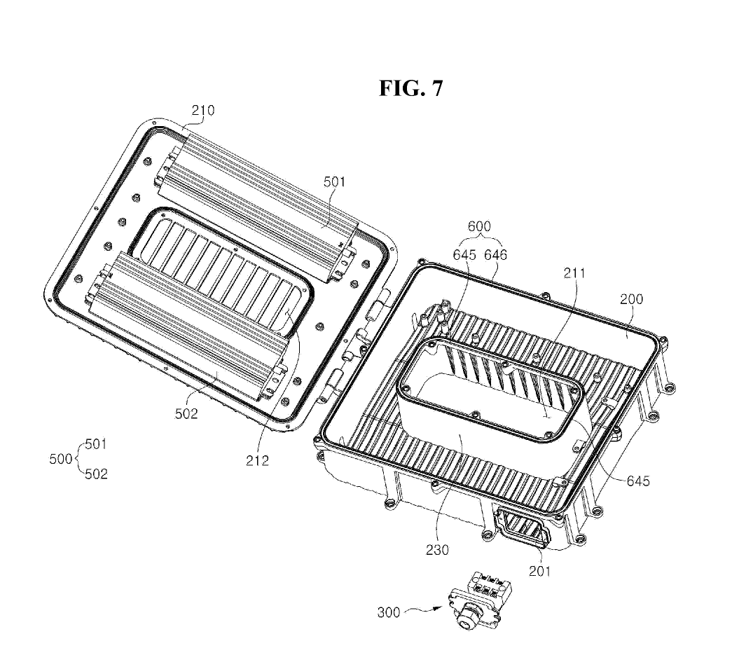

Meanwhile, FIG. 6 is a cross-sectional view showing an inside structure of an optical semiconductor illuminating apparatus according to another exemplary embodiment of the present invention and FIG. 7 is a perspective view showing an inside structure of a casing part, which is the main part of the optical semiconductor illuminating apparatus according to another exemplary embodiment of the present invention.

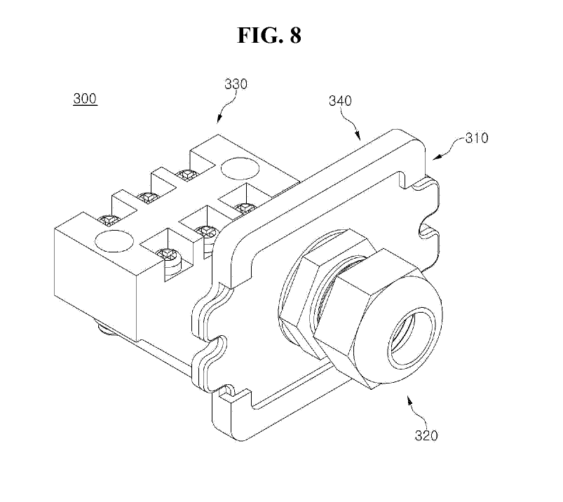

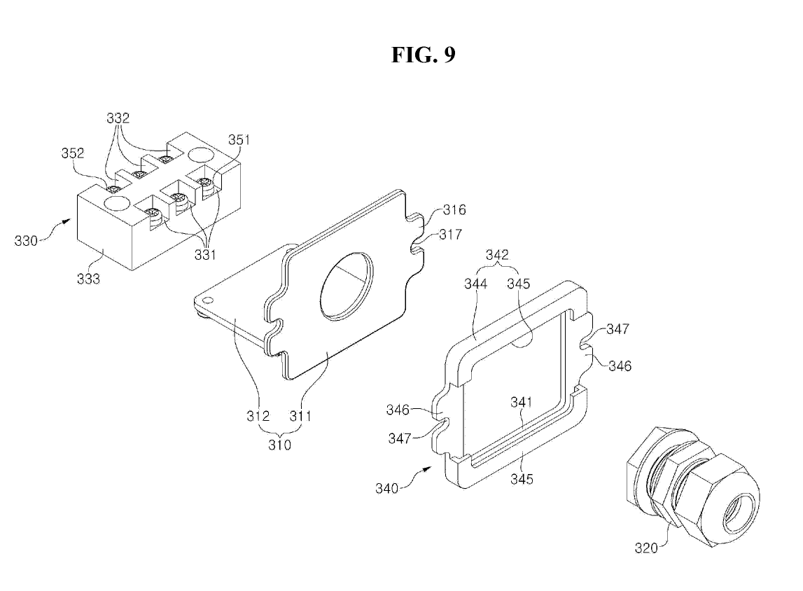

In addition, FIG. 8 is a perspective view showing an overall structure of a first airtightness part, which is the main part of the optical semiconductor illuminating apparatus according to another exemplary embodiment of the present invention and FIG. 9 is an exploded perspective view showing an overall structure of the first airtightness part, which is the main part of the optical semiconductor illuminating apparatus according to another exemplary embodiment of the present invention.

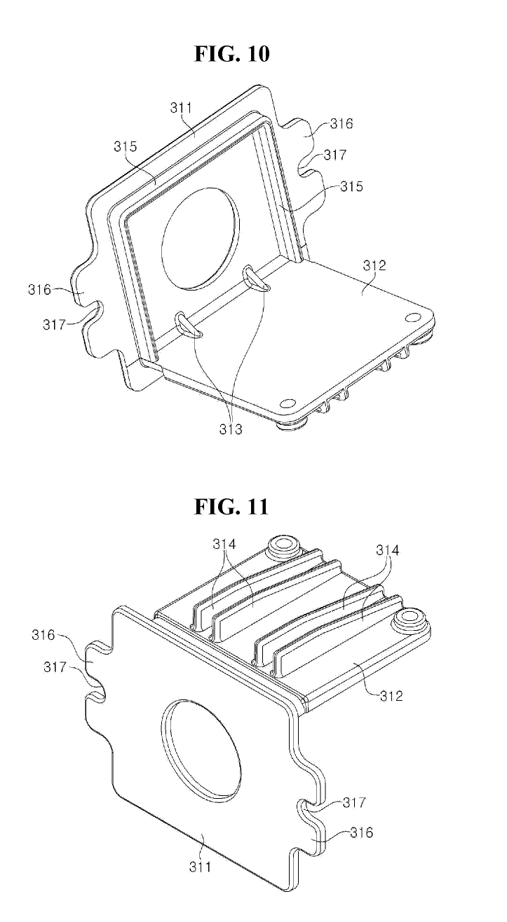

In addition, FIGS. 10 and 11 are perspective views of a structure of a supporting part of the first airtightness part, which is the main part of the optical semiconductor illuminating apparatus according to another exemplary embodiment of the present invention, viewed from various points.

As shown, it may be understood that the present invention has a structure including the light emitting module 100, the casing part 200, the first airtightness part 300, and the second airtightness part 600.

The light emitting module 100 includes the semiconductor optical element 400 and the semiconductor optical element 400 functions as the light source.

The casing part 200 is disposed over the light emitting module 100 and embeds a switching mode power supply (hereinafter, referred to as ‘SMPS’) 500.

The first airtightness part 300 includes a packing frame 340 fixed to an outer side of an edge of the communication slot 201 penetrating through the side surface of the casing part 200 and serves to prevent the introduction of water and foreign materials from the outside.

Further, the second airtightness part 600 is provided to the upper portion of the casing part 200 and serves to prevent the introduction of the water and foreign materials from the outside.

Therefore, according to the present invention, since the first airtightness part 300 and the second airtightness part 600 doubly and surely maintain the waterproofing and airtightness, it is possible to prevent accidents such as an electrical short, an electric shock accident, and the like, in advance.

According to the present invention, the example as described above may be applied, and various examples as follows may also be applied.

First, the first airtightness part 300 also serves to electrically connect a first cable (hereinafter, not shown) for power supply which is led and a second cable (hereinafter, not shown) of the SMPS 500 embedded in the casing part 200 to each other, in addition to the waterproofing function as described above.

Referring to FIGS. 8 and 9, it may be understood that the first airtightness part 300 has a structure that generally includes a supporting part 310, a cable gland 320, a connecting part 330, and the packing frame 340.

The supporting part 310 is fixed to the packing frame 340, the cable gland 320 is fixed to the supporting part 310 and has the first cable penetrating through the cable gland 320, and the connecting part 330 is coupled to the supporting part 310 to connect the first cable and the second cable to each other.

In more detail, it may be understood that the supporting part 310 has a structure including a supporting piece 311 having the cable gland 320 coupled to a central part thereof and finishing the communication slot 201, and an extension piece 312 extended from an edge of the supporting piece 311 to an inner portion of the casing part 200.

Here, the connecting part 330 to be described below is fixed to an upper surface of the extension piece 312.

In this case, the first airtightness part 300 may further include one or more reinforcement pieces 313 (hereinafter, see FIG. 10) provided along a corner at which the supporting piece 311 and the extension piece 312 are joined.

That is, the reinforcement piece 313 is to maintain structural strength against force or pressure applied during a fastening process using a fastening equipment such as a screwdriver, an electrical screwdriver, or the like during a process in which end portions of the first and second cables are connected to the connecting part 330 to be described below which is fixed to the upper surface of the extension piece 312.

The first airtightness part 300 may also further include a plurality of reinforcement ribs 314 (hereinafter, see FIG. 11) protruding from a bottom surface of the extension piece 312 in order to further improve the structural strength together with the reinforcement piece 313.

Meanwhile, the packing frame 340 is a member made of an elastic material which surrounds the edge of the supporting piece 311 and is closely adhered to the outer side of the edge of the communication slot 201.

Here, the supporting part 310 may further include a fixing rib 315 (hereinafter, see FIG. 10) that protrudes to correspond to an edge shape of the packing frame 340 on a rear surface of the supporting piece 311, so as to determine an accurate mounting position of the packing frame 340.

In more detail, it may be understood that the packing frame 340 has a structure in which a frame body 341 includes a fixing pocket 342.

The frame body 341 is a member of a frame shape which is closely adhered to the outer side of the edge of the communication slot 201 and corresponds to the edge of the supporting piece 311.

The fixing pocket 342 is extended from edges at both sides of the frame body 341 to surround the edges at both sides of the supporting piece 311.

Here, the packing frame 340 further includes a plurality of closely adhering ribs 343 (hereinafter, see FIG. 6) that protrude from the rear surface of the frame body 341 facing the outer side of the edge of the communication slot 201, so as to increase friction force on the outer side of the edge of the communication slot 201, that is, the outer surface of the casing part 200, thereby making it possible to maintain the waterproofing and airtightness with stronger adhesion.

In this case, since the respective closely adhering ribs 343 form a plurality of barriers between the closely adhering ribs 343 and the outer surface of the casing part 200 when the plurality of closely adhering ribs 343 protrude from the rear surface of the frame body 341 and are closely adhered to the outer surface of the casing part 200, the structure in which it is difficult for the water and foreign materials to penetrate therethrough is formed, thereby making it possible to maintain the waterproofing and airtightness.

In addition, the fixing pocket 342 includes a contact rib 344 extended from the edges at both sides of the frame body 341 to be in contact with the edges at both sides of the supporting piece 311, and a cover rib 345 extended from an edge of the contact rib 344 to cover a portion of the outer surface of the supporting piece 311, so as to generally form a pocket shape, thereby making it possible to fix the edges at both sides of the supporting piece 311 while accommodating the edges at both sides of the supporting piece 311.

Meanwhile, the supporting piece 311 may further include blade pieces 316 each extended from edges at both sides, and fixing cut parts 317 formed to be each cut from edges of the blade pieces 316 to inner sides thereof and having bolts coupled thereto and heads of the bolts fixed thereto, in order to surely and firmly maintain fastening force on the outer surface of the casing part 200.

It may be seen that the blade pieces 316 described above are extended between the fixing pockets 342.

In addition, in order to continue to maintain a closely adhered supporting state of the blade pieces 316 and the fixing cut parts 317, that is, the waterproofing and airtightness state, the frame body 341 may also be provided with supporting pads 346 and pad cutting parts 347.

The supporting pads 346 are each extended from the edges at both sides of the frame body 341 that does not have the fixing pocket 342, so as to be closely adhered to the outer surface of the edge of the communication slot 201 and support the blade pieces 316.

The pad cutting parts 347 are formed to be each cut from the edges of the supporting pads 346 to inner sides thereof to correspond to the fixing cut parts 317.

That is, since the supporting pads 346 and the pad cutting parts 347 are formed in a shape corresponding to the blade pieces 316 and the fixing cut parts 317 of both sides of the supporting piece 311, it may be said that the supporting pads 346 and the pad cutting parts 347 are technical means provided to maintain the waterproofing and airtightness around a fixing equipment and the casing part 200 even though the supporting piece 311 is fixed with the fixing equipment such as the bolt, or the like.

Meanwhile, it may be understood that the connecting part 330 has a structure in which a terminal block 333 includes first step parts 331 and second step parts 332.

The terminal block 333 is coupled to the supporting part 310, that is, the upper surface of the extension piece 312, so as to be embedded in the casing part 200.

A plurality of first step parts 331 are formed to be stepped along one side edge of the terminal block 333 and face the cable gland 320, and a plurality of second step parts 332 are formed to be stepped along the other side edge of the terminal block 333.

Therefore, the first cable and the second cable are each connected to the first step parts 331 and the second step parts 332. In order to fix a wire of the first cable, first screws 351 are fastened to the plurality of first step parts 331, respectively, and in order to fix a wire of the second cable, second screws 352 are fastened to the plurality of second step parts 332, respectively.

Meanwhile, referring to FIGS. 6 and 7, it may be understood that the second airtightness part 600 has a structure including a first sealing member 645 mounted along an upper end edge of a partition part 230 protruding along an edge of the first bent slot 211 penetrating through the bottom surface of the casing part 200, so as to be fixed to be closely adhered to an edge of the second bent slot 212 of the cover 210, and a second sealing member 646 mounted along an upper end edge of the casing part 200 so as to be closely adhered and fixed to an edge of the cover 210.

In order to describe the second airtightness part 600 in more detail, there is a need to first describe an internal structure of the casing part 200.

The casing part 200 further includes the cover 210 that opens and closes an opened upper surface of the casing part 200, and the partition part 230 extended along the edge of the first bent slot 211 to protrude from the bottom surface of the casing part 200 so as to be in contact with the edge of the second bent slot 212 of the cover 210.

Therefore, the second airtightness part 600 is mounted along an opened upper surface edge of the casing part 200 and the upper end edge of the partition part 230.

That is, the first sealing member 645 is mounted along the upper end edge of the partition part 230 and is fixed to be closely adhered to the edge of the second bent slot 212 of the cover 210, and the second sealing member 646 is mounted along the upper end edge of the casing part 200 and is fixed to be closely adhered to the edge of the cover 210.

In addition, although not particularly shown, the first sealing member 645 and the second sealing member 646 may also form the plurality of closely adhering ribs along the formation direction of the first and second sealing members 645 and 646 such as the plurality of closely adhering ribs 343 protruding from the rear surface of the frame body 341.

The plurality of closely adhering ribs provided along the formation direction of the first and second sealing members 645 and 646 form the plurality of barriers such as the closely adhering ribs 343 of the frame body 341 when the cover 210 closes the casing part 200, which makes the penetration of the water and foreign material difficult, thereby making it possible to implement waterproofing and airtightness performance.

Therefore, according to the present invention as described above, the second airtightness part 600 may doubly maintain the waterproofing and airtightness from an upper portion and a side portion of the casing part 200 together with the first airtightness part 300.

According to the present invention as described above, it may be seen that the object of the present invention is to provide the optical semiconductor illuminating apparatus capable of improving heat dissipation performance by inducing natural convection across inner and outer portions of the optical semiconductor illuminating apparatus, which may be simply installed and constructed and actively take action against various construction environments such as expansion and reduction due to the assembling and fastening, and surely implementing the waterproofing and airtightness and improving workability even in a case of maintenance such as the repair, the replacement, and the like.

According to the present invention having the configuration as described above, the following effects may be accomplished.

First, according to the present invention, the air is naturally ventilated between the first light emitting module and the second light emitting module which are disposed in parallel to each other while being spaced apart from each other by a predetermined distance to induce the natural convection, thereby making it possible to improve the heat dissipation performance.

In some cases, a fan is mounted between the first and second light emitting modules and the supporting unit to induce a forced convection, thereby making it possible to further increase cooling efficiency.

In addition, according to the present invention, for the module block including the first light emitting module and the second light emitting module that include the semiconductor optical elements, the supporting unit allows for the state in which the first light emitting module and the second light emitting module are disposed to be in parallel to each other while being spaced apart from each other a predetermined distance to thereby expand or reduce the area of the first light emitting module and the second light emitting module according to assembling and fastening, thereby making it possible to actively take action against various construction environments.

Particularly, according to the present invention, a relatively simple structure in which the supporting unit may fasten and fix both end portions of the first light emitting module and the second light emitting module, respectively, is used, whereby the installation and construction may be simply performed regardless of skill and convenience of the work may be promoted.

Meanwhile, according to the present invention, since the first airtightness part provided to the side surface of the casing part and the second airtightness part provided to the upper portion of the casing part doubly prevent the water and foreign materials from being introduced, the waterproofing and airtightness performance may be surely maintained, thereby making it possible to prevent the accidents such as the electrical short, the electric shock accident, and the like, in advance.

Particularly, according to the present invention, since the plurality of closely adhering ribs protruding from the frame body of the packing frame configuring the first airtightness part form the plurality of barriers while being closely adhered to the outer surface of the casing part, which makes the penetration of the water and foreign material difficult, the waterproofing and the airtightness performance may be implemented.

In addition, according to the present invention, since the same closely adhering ribs as the closely adhering ribs of the first airtightness part are also formed in the first and second sealing members configuring the second airtightness part, the same waterproofing and airtightness performance may also be implemented.

In addition, according to the present invention, since the structure of the first airtightness part by which the first cable for power supply led from the outside and the second cable of the SMPS in the casing part are connected to each other is used, the workability may be improved even in the case of maintenance such as the repair, the replacement, and the like.

Particularly, according to the present invention, since the first cable and the second cable may be detachably connected to each other through the connecting part coupled to the supporting part, if the supporting part coupled to the communication slot is only separated from the casing part, the problem for a connection terminal portion of the cable may be immediately detected and may be actively handled.

In addition, various modifications and applications may be made by those skilled in the art without departing from the scope of the basic technical spirit of the present invention.

What is claimed is:

1. An optical semiconductor illuminating apparatus comprising:
a light emitting module including semiconductor optical elements;
a casing part disposed over the light emitting module and having a switching mode power supply (SMPS) embedded therein;
a first airtightness part including a packing frame fixed to an outer side of an edge of a communication slot penetrating through a side surface of the casing part and preventing water and foreign materials from being introduced from the outside; and
a second airtightness part provided to an upper side of the casing part to prevent the water and foreign materials from being introduced from the outside.

2. The optical semiconductor illuminating apparatus of claim 1, wherein the first airtightness part electrically connects a first cable for power supply led from the outside of the casing part and a second cable of the SMPS embedded in the casing part.

3. The optical semiconductor illuminating apparatus of claim 1, wherein the first airtightness part includes:
a supporting part fixed to the packing frame;
a cable gland fixed to the supporting part and having the first cable penetrating therethrough; and
a connecting part coupled to the supporting part and connecting the first cable and the second cable to each other.

4. The optical semiconductor illuminating apparatus of claim 3, wherein the supporting part includes:
a supporting piece having a central part coupled to the cable gland and fixed to the packing frame to finish the communication slot, and
an extension piece extended from an edge of the supporting piece to an inner portion of the casing part, and
the connecting part is fixed to an upper surface of the extension piece.

5. The optical semiconductor illuminating apparatus of claim 3, wherein the connecting part includes:
a terminal block coupled to the supporting part and embedded in the casing part,
a plurality of first step parts formed to be stepped along one side edge of the terminal block and facing the cable gland, and
a plurality of second step parts formed to be stepped along the other side edge of the terminal block, and
the first cable and the second cable are connected to the first step parts and the second step parts, respectively.

6. The optical semiconductor illuminating apparatus of claim 4, wherein the first airtightness part further includes one or more reinforcement pieces provided along a corner of the connecting part at which the supporting piece and the extension piece are joined.

7. The optical semiconductor illuminating apparatus of claim 4, wherein the first airtightness part further includes a plurality of reinforcement ribs protruding in a direction which is perpendicular to the supporting piece along a bottom surface of the extension piece.

8. The optical semiconductor illuminating apparatus of claim 4, wherein the supporting part further includes a fixing rib that protrudes to correspond to an edge shape of the packing frame on a rear surface of the supporting piece.

9. The optical semiconductor illuminating apparatus of claim 4, wherein the packing frame includes:
a frame body of a frame shape closely adhered to the outer side of the edge of the communication slot and corresponding to the edge of the supporting piece, and
a fixing pocket extended from edges at both sides of the frame body and surrounding edges at both sides of the supporting piece.

10. The optical semiconductor illuminating apparatus of claim 9, wherein the packing frame further includes a plurality of closely adhering ribs protruding from a rear surface of the frame body facing the outer side of the edge of the communication slot.

11. The optical semiconductor illuminating apparatus of claim 10, wherein the plurality of closely adhering ribs are disposed to be in parallel to each other along a formation direction of the frame body.

12. The optical semiconductor illuminating apparatus of claim 9, wherein the fixing pocket includes:
a contact rib extended from the edges at both sides of the frame body to be in contact with the edges at both sides of the supporting piece, and
a cover rib extended from an edge of the contact rib to cover a portion of an outer surface of the supporting piece.

13. The optical semiconductor illuminating apparatus of claim 4, wherein the supporting piece further includes:
blade pieces extended from edges at both sides, respectively, and
fixing cut parts formed to be each cut from edges of the blade pieces to an inner side thereof, and having bolts coupled thereto and heads of the bolts fixed thereto.

14. The optical semiconductor illuminating apparatus of claim 9, wherein the supporting piece further includes:
blade pieces extended from edges at both sides, respectively, to face an outer surface of the edge of the communication slot, and
fixing cut parts formed to be each cut from edges of the blade pieces to an inner side thereof, and having bolts coupled thereto and heads of the bolts fixed thereto, and
the blade pieces are extended between the fixing pockets provided to the frame body.

15. The optical semiconductor illuminating apparatus of claim 14, wherein the frame body further includes:
supporting pads each extended from the edges at both sides of the frame body that does not have the fixing pocket to be closely adhered to the outer surface of the edge of the communication slot and support the blade pieces, and
pad cutting parts formed to be each cut from edges of the supporting pads to inner sides thereof so as to correspond to the fixing cut parts.

16. The optical semiconductor illuminating apparatus of claim 5, wherein the connecting part further includes:
first screws fastened to the first step parts, respectively, and fixing a wire of the first cable, and
second screws fastened to the second step parts, respectively, and fixing a wire of the second cable.

17. The optical semiconductor illuminating apparatus of claim 1, wherein the second airtightness part includes:
a first sealing member mounted along an opened upper surface edge of the casing part, and
a second sealing member mounted along an upper end edge of a partition part protruding along an edge of the bent slot penetrating through a bottom surface of the casing part.

18. The optical semiconductor illuminating apparatus of claim 17, wherein the second airtightness part further includes a plurality of closely adhering ribs protruding along a formation direction of the first sealing member.

19. The optical semiconductor illuminating apparatus of claim 17, wherein the second airtightness part further includes a plurality of closely adhering ribs protruding along a formation direction of the second sealing member.

20. The optical semiconductor illuminating apparatus of claim 1, further comprising:
a cover opening and closing an opened upper surface of the casing part; and
a bent slot penetrating through the cover and a bottom surface of the casing part to partition the accommodating space,
wherein the second airtightness part is provided to an edge of the opened upper surface of the casing part and an edge of the bent slot.

21. The optical semiconductor illuminating apparatus of claim 20, wherein the casing part further includes a partition part extended along the edge of the bent slot to protrude from the bottom surface of the casing part and having an upper end edge which is in contact with the bent slot of the cover, and
the second airtightness part is provided along the edge of the opened upper surface of the casing part and the upper end edge of the partition part.

22. The optical semiconductor illuminating apparatus of claim 21, wherein the second airtightness part includes:
a first sealing member mounted along the upper end edge of the partition part to be closely adhered to the bent slot of the cover, and
a second sealing member mounted along an upper end edge of the casing part to be closely adhered to an edge of the cover.
